(19) United States
(12) Patent Application Publication
(10) Pub. No.: US 2026/0365577 A1
(43) Pub. Date: Nov. 19, 2026

(54) 3D PRINTABLE CEMENT BASED MATERIALS WITH GRAPHENE

(71) Applicants: HydroGraph Clean Power Inc., Vancouver (CA); Arizona Board of Regents on behalf of Arizona State University, Phoenix, AZ (US)

(72) Inventors: Ranjith Divigalpitiya, London (CA); Sahil Surehali, Phoenix, AZ (US); Narayanan Neithalath, Chandler, AZ (US)

(21) Appl. No.: 19/677,321

(22) Filed: May 14, 2026

Related U.S. Application Data
(60) Provisional application No. 63/805,940, filed on May 14, 2025.

(51) Int. Cl. C04B 24/40; B28B 1/00; B33Y 10/00; B33Y 30/00; B33Y 70/10; C04B 24/28; C04B 28/04; C04B 111/00

(52) U.S. Cl. CPC C04B 24/405; B28B 1/001; B33Y 10/00; B33Y 30/00; B33Y 70/10; C04B 24/283; C04B 28/04; C04B 2111/00181

(57) ABSTRACT

A 3D-printable cementitious mixture. The 3D-printable cementitious mixture includes hydraulic cement, water, a superplasticizer, and fractal graphene (FG) or reactive fractal graphene (RG). The fractal graphene (FG) or reactive fractal graphene (RG) is in an amount of 0.01% to 0.02% by mass of binder.

### CROSS-REFERENCE TO RELATED APPLICATION

The application claims priority to U.S. Provisional Patent Application No. 63/805,940, filed on May 14, 2025, entitled “3D PRINTABLE CEMENT BASED MATERIALS WITH GRAPHENE,” the entire contents of the application are incorporated herein by reference.

### TECHNICAL FIELD

The present disclosure generally relates to cement based materials and specifically to improved cement based materials by the addition of specialty graphene products.

### BACKGROUND

Unless otherwise indicated herein, the materials described in this section are not prior art to the claims herein and are not admitted as being prior art by inclusion in this section.

Graphene, a two-dimensional nanomaterial, has gained immense popularity since its discovery, mainly due to its very high tensile strength (130 GPa; for comparison, the tensile strength of steel is <1 GPa) and elastic modulus (1.1 TPa). Graphene and its derivatives, such as graphene nanoplatelets (GNPs), graphene oxide (GO), and reduced graphene oxide (rGO) may improve the properties of cement based materials. GO features numerous hydroxyl, carboxyl, epoxy, and other functional groups on the graphene surface, rGO is synthesized by partially reconstituting the graphene lattice by removing the oxidized functional groups via reducing agents, and GNPs are difficult to disperse in aqueous solutions as they form entangled clumps because of the highly attractive van der Waals forces between the platelets.

Fractal graphene (FG) and reactive fractal graphene (RG) may be obtained through a cost-effective and scalable chamber explosion synthesis.

### SUMMARY

Existing challenges associated with cement based materials, as well as other challenges, are overcome by the presently disclosed cement based materials with graphene. One embodiment of the present disclosure is a 3D-printable cementitious mixture. The 3D-printable cementitious mixture includes hydraulic cement, water, a superplasticizer, and fractal graphene (FG) or reactive fractal graphene (RG). The fractal graphene (FG) or reactive fractal graphene (RG) is in an amount of 0.01% to 0.02% by mass of binder.

In aspects, the mixture exhibits a mini slump value between about 3 mm and about 6 mm.

In aspects, the static yield stress evolution follows an exponential function indicative of enhanced structuration and early-age strength development.

In aspects, the fractal graphene (FG) is produced through chamber explosion synthesis.

In aspects, the reactive fractal graphene (RG) comprises fractal graphene (FG) functionalized with carboxyl (—COOH) groups.

In aspects, the 3D-printable cementitious mixture has a viscosity recovery of at least 95% after extrusion.

In aspects, the superplasticizer is a polycarboxylate ether (PCE)-based superplasticizer.

In aspects, the mixture exhibits a dynamic yield stress at least about two times greater than a corresponding mixture without graphene.

In aspects, the mixture has increased thixotropy relative to a control composition without graphene.

Another embodiment of the present disclosure includes a method of producing a graphene-enhanced cementitious composition. The method includes dispersing fractal graphene (FG) or reactive fractal graphene (RG) in water using ultrasonication, mixing the dispersed graphene with a hydraulic cement, and adding water to achieve a desired water-to-cement ratio.

In aspects, the ultrasonication process is performed at a frequency of 40 KHz.

In aspects, the ultrasonication process is performed for at least 30 minutes.

In aspects, a superplasticizer is added during the dispersion process to improve the stability of the graphene suspension.

In aspects, the fractal graphene (FG) or reactive graphene (RG) is homogenized in water prior to ultrasonication.

In aspects, the dispersing step further comprises adding a superplasticizer at a mass ratio of about 1:1 relative to the fractal graphene (FG) or reactive fractal graphene (RG).

Another embodiment of the present disclosure is a method for additive manufacturing of a cementitious structure. The method includes preparing a 3D-printable cementitious mixture including fractal graphene (FG) or reactive fractal graphene (RG). The method includes extruding the mixture layer-by-layer using a 3D printing system and allowing the printed structure to gain strength through controlled hydration and structuration.

In aspects, the extruding is performed using a robotic or gantry-based 3D printer.

In aspects, the cementitious mixture exhibits a buildable height at least about two times greater than a comparable mixture without graphene.

In aspects, the printed structure exhibits enhanced early-age strength due to accelerated hydration.

In aspects, the cementitious mixture exhibits a viscosity recovery of at least 95% after extrusion, enabling the printed structure to retain shape stability during layer-by-layer deposition.

The foregoing summary is illustrative only and is not intended to be in any way limiting. In addition to the illustrative aspects, embodiments, and features described above and below, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates the structures of graphene oxide (GO), reduced graphene oxide (rGO), fractal graphene (FG), and reactive fractal graphene (RG) in accordance with the present disclosure;

FIGS. 2A and 2B illustrate transmission electron microscopy (TEM) images of fractal graphene (FG) in accordance with the present disclosure;

FIG. 3A illustrates X-ray diffraction (XRD) spectra of fractal graphene (FG) and reactive fractal graphene (RG) and FIG. 3B illustrates characteristic G-band, D-band, and 2D-bands of fractal graphene (FG) and reactive fractal graphene (RG) in accordance with the present disclosure;

FIG. 4A illustrates yield stress and plastic viscosity, FIG. 4B illustrates a comparison of yield stress and mini slump values of the pastes, and FIG. 4C illustrates hysteresis loop area of the control, FG and RG modified pastes in accordance with the present disclosure;

FIG. 5A illustrates static yield stress evolution with time, FIG. 5B illustrates structuration rate, Aₜₕᵢₓ, and characteristic time, t_{c}, for a control paste and FG and RG modified pastes, and FIG. 5C illustrates the relationship between the structuration parameter and the hysteresis loop area in accordance with the present disclosure;

FIG. 6A illustrates storage and loss moduli, FIG. 6B illustrates phase angle, and FIG. 6C illustrates critical strain (%) extracted from oscillatory strain sweep tests on the control, FG- and RG-modified pastes in accordance with the present disclosure;

FIG. 7A illustrates storage modulus evolution with time, and FIG. 7B illustrates model fit results of control, FG and RG modified pastes in accordance with the present disclosure;

FIG. 8A illustrates representative viscosity recovery curves of the control paste and FG modified pastes, FIG. 8B illustrates representative viscosity recovery curves of the control paste and RG modified pastes, and FIG. 8C illustrate viscosity recovery (buildability) rate of the control paste and FG and RG modified pastes showing the final viscosity as % of the initial viscosity of the pastes in accordance with the present disclosure;

FIG. 9A illustrates representative stress-strain relationships from GCT for the control, FIG. 9B illustrates representative stress-strain relationships from GCT for FG-0.02 mortar mixtures, and FIG. 9C illustrates representative stress-strain relationships from GCT for RG-0.02 mortar mixtures in accordance with the present disclosure; and

FIG. 10 illustrates the key stages in 3D printing and highlights the rheological properties that exhibit strong correlations with oscillatory rheology-based parameters in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

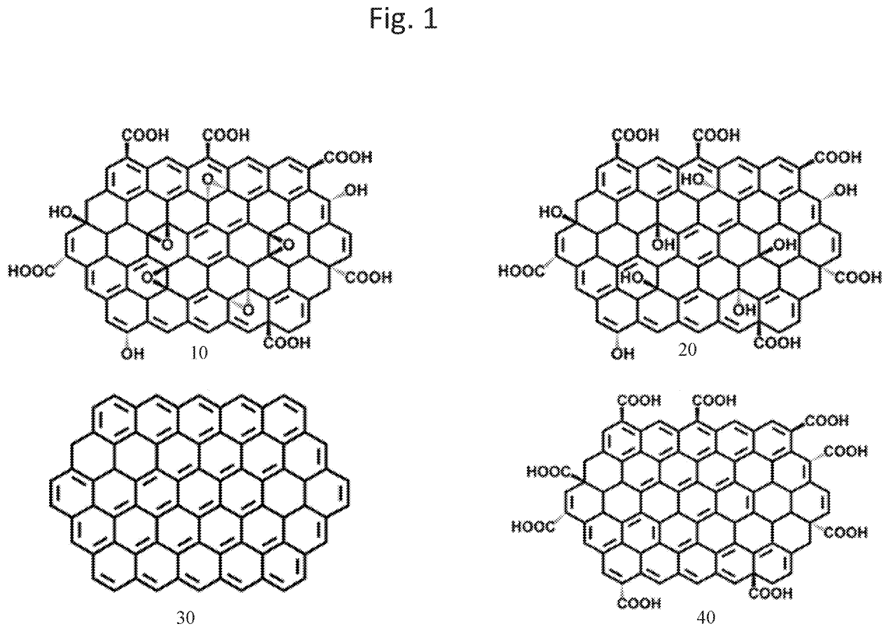

FIG. 1 illustrates the structures of graphene oxide (GO), reduced graphene oxide (rGO), fractal graphene (FG), and reactive fractal graphene (RG) in accordance with at least some embodiments described herein.

Fractal graphene (FG) 30 may be produced through a cost-effective, and eco-friendly one-step method that involved controlled explosion of an acetylene-oxygen mixture in a chamber under a spark. Chamber explosion synthesis of FG 30 is fast, catalyst-free, and an economically viable method to produce high-quality graphene. The chamber explosion process produces high temperatures (~3000 K) and pressures (≤300 psi), along with a supersonic chamber explosion (combustion) wave that induces the conversion of acetylene into free carbon atoms, which subsequently condense into carbon nanoparticles upon cooling. The powder aggregates quickly to form an aerosol gel inside the container to yield FG 30; graphene with a fractal structure. Chamber explosion synthesis of FG 30 does not produce carbonaceous soot as the chamber explosion temperature is much higher than the temperature for soot production. All production subprocesses are carried out in the gas phase without any catalysts, resulting in production of FG 30 which is elementally pure graphene with carbon content >99% with high batch-to batch consistency.

Reactive fractal graphene (RG) 40 is produced from FG 30 by functionalizing the FG 30 with COOH groups on the surface using a Fenton oxidation process, thereby making RG 40 which is suitable for dispersion. Fenton oxidation is defined as the oxidation of organic materials by Fenton's reagent (hydrogen peroxide and Fe2+). Compared to the commonly used Hummer's method to produce graphene oxide (GO) 10, the preferential reaction of Fenton's reagent with the edges of FG 30 leads to the formation of less defective oxides in RG 40. FIG. 1 shows a comparison between the structure of conventional GO 10 and rGO 20, with FG 30 and RG 40 presented in this disclosure. While traditional GO 10 may contain multiple types of oxygen containing moieties such as hydroxyl, carbonyl, carboxylic, and epoxide groups attached to both surfaces, as shown in FIG. 1, RG 40 contains only carboxylic groups. The chamber explosion synthesis process is energy efficiency over other methods for producing graphene and unlike other graphene manufacturing techniques, the chamber explosion-based process is devoid of any rotating machinery, consumes minimal energy, and operates without solvents, thereby eliminating greenhouse gas (GHG) emissions. The process leverages the exothermic reaction between acetylene and oxygen and requires substantially less energy per kg of graphene compared to traditional manufacturing techniques such as ultrasonic exfoliation, Hummer's method, and flash Joule heating. In addition to very low energy demand, the chamber explosion synthesis process does not use water, while producing high-value syngas as the sole byproduct, which can be effectively captured and repurposed for diverse applications. The Fenton process that converts FG 30 to RG 40 eliminates the disadvantages of conventional GO 10 production techniques (e.g., Hummer's method) because the Fe and H₂O₂ utilized are cheap and environmentally innocuous, the H₂O₂ activation occurs at ambient temperature and pressure, and the reactions do not generate toxic gases. Thus, the manufacturing processes of FG 30 and RG 40 are significantly less expensive compared to traditional processes. In some embodiments, the use of FG 30 and RG 40 provides sustainability advantages over conventional graphene materials. The detonation synthesis process used to produce FG 30 and RG 40 is energy-efficient, solvent-free, and scalable, resulting in lower global warming potential and energy demand compared to traditional graphene production methods. When incorporated into cementitious systems, these FG 30 and RG 40 materials enable reduction in cement content while maintaining or improving mechanical performance. Life cycle analysis indicates that FG 30 and RG 40 graphene-modified mixtures can achieve up to approximately 15% lower normalized energy demand and greenhouse gas emissions when adjusted for strength performance.

As described earlier, RG 40 is essentially FG 30 functionalized with COOH groups. The chemical composition of FG 30 and RG 40 are provided in Table 1, below along with those of GO 10 and rGO 20, to demonstrate the purity of the graphene used.

TABLE 1
Chemical Composition of Fractal Graphene (FG),
Reactive Fractal Graphene (RG), Graphene Oxide
(GO), and Reduced Graphene Oxide (rGO)

| | fractal | reactive | graphene | reduced |
|---|---|---|---|---|
| | graphene | graphene | oxide | graphene oxide |
| element | (FG) | (RG) | (GO) | (rGO) |
| C % | 99.2 | 90.1 | 44 | 56 |
| O % | 0.7 | 8.2 | 53 | 41 |
| H % | 0.1 | 1.7 | 3 | 3 |

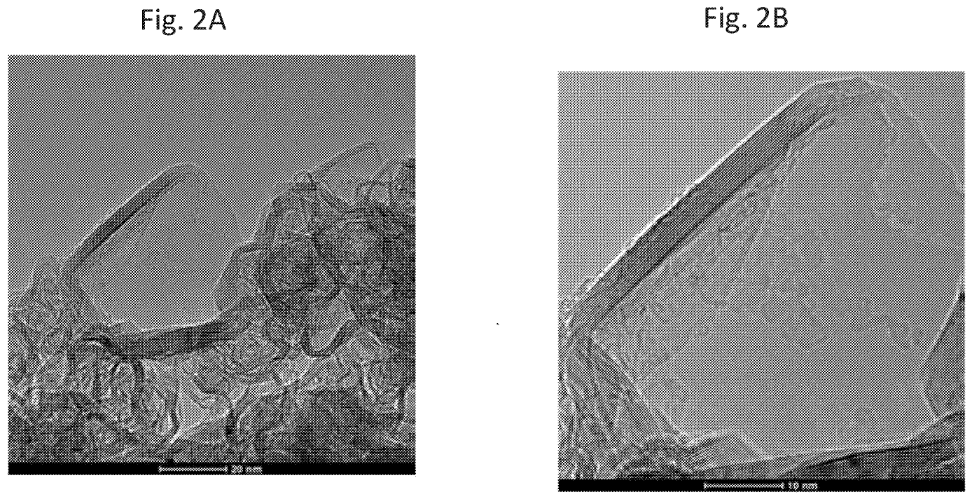

FIGS. 2A and 2B illustrate transmission electron microscopy (TEM) images of fractal graphene in accordance with at least some embodiments described herein. Transmission electron microscopy (TEM) images of FG 30 are shown in FIGS. 2A and 2B, which depict geometric attributes of FG 30, with lateral dimensions of 20-50 nm, and a z-axis dimension of <5 nm. On average, each particle contains 6-10 layers. The TEM images also show some crumpling of layers consistent with the morphology of graphene synthesized using other methods. The dimensions of FG 30 produced by chamber explosion synthesis are much smaller than those of GOs and GNPs, which is typically on the order of 100 nm. Experimental specific surface area (SSA) of graphene is determined to be ~200 m2 g-1, which is an order of magnitude lower than the theoretical SSA of 2630 m2 g-1 for isolated graphene sheets obtained under a rigorous dispersion scheme (e.g., ultrasonication).

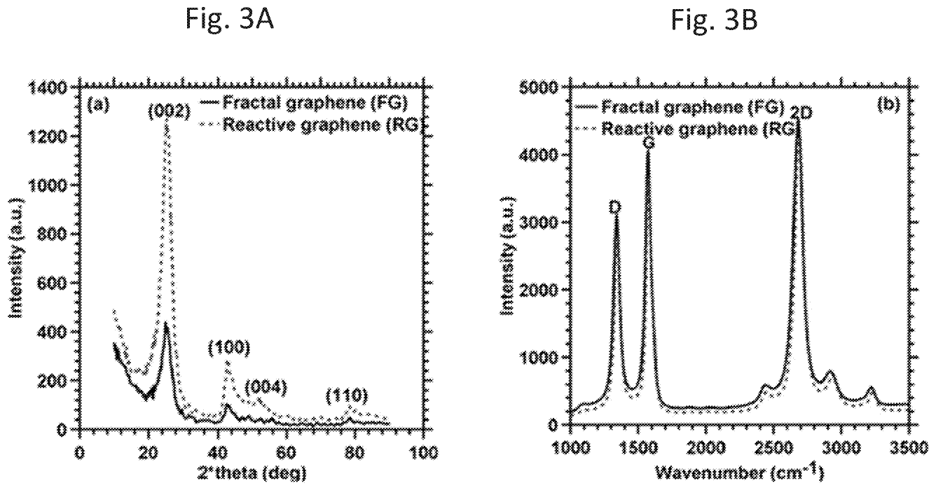

X-ray diffraction (XRD) spectra of FG 30 and RG 40 are shown in FIG. 3A. The most intense peak (002) is centered at ~26°, implying an interplanar spacing (d) of 0.341 nm, which is similar with graphene synthesized using other methods. FIG. 3b shows the Raman spectra of FG 30 and RG 40, measured at an excitation wavelength of 514 nm. The G-band is the primary mode in graphene, representing the planar configuration of sp2-bonded carbon in graphene. The G-band position also indicates the number of layers (z-axis dimension), with a shift to the right indicating a greater number of layers. Shifts in the G-band position also could indicate doping. D-band or defect-band indicates the partially disordered structures of the sp2 domains, while the 2D-band, a strong band in graphene, is more sensitive to graphene folding and is used to probe graphene thickness. Characteristic G-band and 2D-bands are observed in FIG. 3B at 1584 and 2690 cm-1. The nanoscale lateral dimensions of platelets lead to a high fraction of defect edge sites, which enhances the intensity of the D-band observed at 1328 cm-1. Both the XRD and Raman spectra are very similar for FG 30 and RG 40.

Type I/II ordinary Portland cement (OPC) conforming to ASTM C 150 provided by the Salt River Materials Group (Phoenix Cement) was used to prepare cement pastes and mortars. The chemical composition of OPC is summarized below in Table 2.

TABLE 2
Chemical Composition and Physical Properties of Ordinary Portland Cement

| chemical composition | | | | | | | | physical properties | |
|---|---|---|---|---|---|---|---|---|---|
| SiO₂ | Al₂O₃ | SO₃ | Fe₂O₃ | MgO | Na₂O | K₂O | CaO | LOI [symbol] | specific |
| (%) | (%) | (%) | (%) | (%) | (%) | (%) | (%) | (%) | gravity |
| 21.3 | 3.78 | 2.88 | 3.75 | 1.77 | 0.25 | 0.17 | 63.8 | 1.34 | 3.20 |

[symbol]

indicates data missing or illegible when filed

The median particle size (d50) of the OPC was determined as 15.2 μm using laser diffraction. The specific gravity was determined using a gas pycnometer in accordance with ASTM D 5550. These parameters are also listed in Table 2. Cement pastes were prepared at a water-to-cement ratio (w/c) of 0.40. Different graphene dosages from 0 to 0.10% by mass of cement were initially used to proportion the cement pastes. Based on the cement content and w/c, the amount of graphene needed for a paste with a certain graphene content was determined and dispersed in water using a procedure described in the following section. Compressive strengths of mortars (50% sand by mass of the binder) were determined at 1, 3, and 7 days to refine (optimize) the graphene dosages for further materials characterization and testing. In some initial screening test embodiments no chemical admixtures were used since the objective was to understand the influence of graphene in cement pastes, and admixtures have the propensity to interact with the functional groups in graphene.

It is important that nanosized graphene is uniformly dispersed in the mixing water to ensure adequate dispersibility in a cementitious matrix or mixture. A cementitious mixture may be a mortar or concrete including OPC. The very small size and attractive van der Waals forces result in the agglomeration of nanosized particles, thereby rendering them less effective in enhancing the properties of cementitious materials. To prepare a well-dispersed graphene suspension, graphene was first homogenized with deionized (DI) water for 2 min. Next, the beaker with the solution was moved into a cell, where the suspension underwent ultrasonication at a frequency of about 40 kHz (and about 400 W power) for about 3 hours. Care was taken to prevent water loss during ultrasonication and to avoid overheating of the solution. While about 3 hours of ultrasonication was utilized in the preparation of the samples, this time may be reduced to 15-30 min with the use of a chemical admixture such as a superplasticizer. The graphene-water suspension was characterized by UV-vis spectrometry using a Hach DR6000 UV/vis spectrophotometer. The measurement was performed in a wavelength range of 250-1100 nm and DI water was used for baseline correction. To further confirm the stability of graphene suspensions as a function of time, solutions containing FG 30 and RG 40 we monitored and showed that the absorbance peak of the UV-vis spectra of the suspension did not change noticeably even after 7 days, thus demonstrating that the dispersion process used in this disclosure can produce stable FG 30 and RG 40 suspensions that can be used in cementitious mixture preparation. Ultrasonication may be utilized for exfoliation of the nanosheets of FG 30 and RG 40 and may provide significant dispersion (as indicated by UV-vis spectroscopy). The graphene-water suspensions were used for the preparation of 3D-printable concrete.

Ordinary Portland cement (OPC) conforming to ASTM C 150 and limestone powder conforming to ASTM C 568 were utilized to proportion pastes used for rheological measurements. The chemical compositions of the OPC and limestone powder are shown in Table 2. OPC was determined to have a median particle size of 15.2 μm, and limestone, 2.15 μm, when measured using a laser particle size analyzer. The specific gravities of OPC, and limestone were determined to be 3.24, and 2.80 respectively, using a gas pycnometer. The control paste used in the disclosure consisted of limestone powder replacing 30% of cement by mass at a water-to-binder (w/b) ratio of 0.35 and aided by the use of a polycarboxylate ether (PCE)-based superplasticizer (at 0.25% by mass of binder). This paste was shown to be suitable for 3D printing. Ultra-low FG 30 and RG 40 graphene dosages of only 0.01% and 0.02% by mass of binder were used to provide a balance between enhancing compressive strength without significantly compromising workability. FG 30 and RG 30 graphene modified pastes were also proportioned with the same w/b and superplasticizer content as that of the control paste.

In some embodiments, FG 30 and RG 30 graphene dosage is optimized within a narrow range (e.g., ≤0.02% by mass of binder) to balance improvements in mechanical and rheological properties with dispersion limitations. At low dosages, FG 30 and RG 30 graphene enhances strength, hydration, and rheology; however, excessive dosages may lead to agglomeration, reduced dispersion efficiency, and diminished performance gains. Experimental studies indicate that optimal performance occurs at low concentrations where FG 30 and RG 30 graphene particles are well-dispersed and effectively interact with the cementitious matrix.

In some embodiments, FG 30 and RG 30 graphene additives are particularly beneficial in cementitious systems incorporating high volumes of supplementary cementitious materials such as fly ash or limestone. While such replacements typically reduce early-age strength, the addition of small amounts of FG 30 and RG 30 compensates for this reduction by accelerating hydration and improving microstructure. This enables the formulation of sustainable, low-cement mixtures that maintain or exceed the performance of conventional systems, making them suitable for advanced applications such as 3D printing and ultra-high-performance concrete.

Since printable pastes are expected to have high consistency, a mini slump cone with a bottom diameter of 38 mm, a top diameter of 19 mm, and a height of 57 mm was used to determine the slump values as an initial indicator of flowability and shape stability of the control and experimental pastes. The FG 30 and RG 30 modified pastes demonstrated considerably lower mini slump values than the control paste, implying that better shape stability can be expected when using these pastes. The mini slump values for all the graphene modified pastes (between 3 and 6 mm, as compared to 15 mm for the control paste) are found to be within the proposed range for acceptable buildability and shape stability. Although mini slump cannot be used as the sole printability criteria, it is used here as an initial indicator to ensure the suitability of the selected w/b ratio and superplasticizer content for FG 30 and RG 40 modified pastes. Mortar mixtures containing 0.02% FG 30 or RG 40 by mass of binder provided early age compressive strength enhancements of ~30-35% and later age enhancements by ~15-20%. In some embodiments, the incorporation of FG 30 or RG 40 leads to refinement of pore structure within the cementitious matrix. FG 30 or RG 40 graphene-modified systems demonstrate reduced porosity and smaller critical pore sizes, in some cases by up to 50% compared to conventional mixtures. This densification is attributed to enhanced hydration, filler effects of nanoscale graphene particles, and improved packing of hydration products. The resulting microstructure provides improved durability characteristics, including reduced permeability and enhanced resistance to environmental degradation, thereby extending service life of the material.

TABLE 3
Chemical composition and physical properties of the binder ingredients.

| | Chemical composition (% by mass) | | | | | | | | |
|---|---|---|---|---|---|---|---|---|---|
| | | | | | | | | | Loss on |
| | SiO₂ | Al₂O₃ | SO₃ | Fe₂O₃ | MgO | Na₂O | K₂O | CaO | ignition |
| Binder ingredient | (%) | (%) | (%) | (%) | (%) | (%) | (%) | (%) | (%) |
| OPC | 21.30 | 3.78 | 2.88 | 3.75 | 1.77 | 0.25 | 0.17 | 63.83 | 1.34 |

| | |
|---|---|
| Limestone (L) | CaCO₃ >99%, when determined using thermogravimetric analysis |

For mortar mixtures proportioned to determine the buildability of the printed mixtures, the binder systems described above were used along with a commercial sand (Quikrete), conforming to ASTM C 778, with a median particle size of 0.5 mm. All the mortars contained 50% sand by mass of the total solids in the mortar.

Based on the binder content and w/b ratio, graphene-water suspensions were prepared by dispersing the requisite amount of graphene FG 30 or RG 40 in deionized (DI) water. A modified, low-duration dispersion process, wherein the superplasticizer is added during the dispersion process, is used in this disclosure, as this has been shown to improve graphene dispersion. Graphene FG 30 or RG 40 was first mixed with DI water for 2 min using a homogenizer. The homogenized suspension was then transferred to an ultrasonicator operating at a frequency of 40 kHz and power of 400 W for a total of 30 min. Superplasticizer (mass ratio of 1:1 to graphene) was added to the solution after 10 min of ultrasonication, after which the ultrasonication was continued for another 20 min. Precautions were taken to prevent evaporation of water during this process and to prevent the solution from overheating. UV-vis spectrophotometry experiments showed that the graphene particles remained suspended in the solution even after 7 days of preparation of the suspension. The graphene-water suspension, along with additional superplasticizer required to achieve the target superplasticizer dosage and rheological properties, was added to the binder powder and mixed in a laboratory mortar mixer.

Dynamic yield stress and plastic viscosity of the pastes were determined using TA instruments AR 2000EX rotational rheometer with a vane-in-cup geometry, which eliminates the issues with slip in rheological measurements. All rheological experiments were carried out with the setup maintained at 25±0.1 °C. The time elapsed between the addition of mixing water and the beginning of the rheological experiment was approximately 5 min. A strain-controlled shear rate ramp test was conducted to determine the relationship between the shear stress of the paste and the applied shear strain. The general experimental procedure consists of: (i) a ramp-up pre-shear phase in steps, from 10-to-100 s⁻¹ for 75 s to homogenize the paste, (ii) an immediate ramp-down to 0.005 s⁻¹, (iii) a second stepped ramp-up phase from 0.005-to-100 s⁻¹, and (iv) a stepped ramp-down phase from 100-to-0.005 s⁻¹. Data is acquired every second in the latter two phases, until three consecutive torque measurements are within 8% of each other. At this time, the experiment advances to the next shear rate. Yield stress and plastic viscosity of the pastes were determined by using the Bingham model (Equation (1)). At least three replicates were performed for each test, and the average values are reported.

τ=μₚ\dot{γ}+τ_{y} (1)
where, τ=shear stress (Pa); μₚ=plastic viscosity (Pa·s⁻¹); \dot{γ}=shear rate (s⁻¹); τ_{y}=yield stress (Pa)

Static yield stress evolution was monitored using a parallel plate configuration. The upper and lower plates were serrated (serration depths of 1 mm and 0.15 mm respectively) to prevent slip on the shearing surface. The sample volume for a 2 mm plate gap was calculated and placed on the bottom plate to avoid overfilling. The stress growth test was performed by applying a constant shear rate of 0.1 s⁻¹. Under a constant shear rate, the shear stress of the paste progressively develops to a maximum value, followed by its reduction to an equilibrium value. The peak shear stress value obtained during the process is defined as static yield stress. The pastes were pre-sheared at a shear rate of 100 s⁻¹ for 1 min, and then the static yield stress value measured until 30 min, at 5 min intervals after initial pre-shearing. The constant shear rate of 0.1 s⁻¹ was applied for 15 s as it was sufficient to capture the peak shear stress for all the pastes.

Oscillatory strain amplitude sweep was performed using vane-in-cup configuration to obtain storage and loss moduli, phase angle, and critical strain. An oscillatory strain was applied in the range of 0.001% to 1000% at a frequency of 1 Hz. This strain range captures the linear viscoelastic regime (LVR) in cementitious suspensions. The critical strain was taken as the strain causing a 10% reduction from the average storage modulus value within the LVR. The experiment duration was minimized to limit the effects of hydration. Small amplitude oscillatory shear (SAOS) tests were also performed to determine storage modulus evolution with time. A pre-shear of 220 s⁻¹ was applied before all the oscillation tests to ensure they all achieved the same reference state, and the tests were carried out at a small strain of 10-4 and a frequency of 1 Hz so that the structural integrity of the flocculated network is maintained. The storage modulus evolution was monitored for 1800 s (30 min). In some embodiments, FG 30 and RG 40 graphene-modified cementitious materials exhibit increased electrical conductivity due to the conductive nature of FG 30 and RG 40 graphene particles. This property enables the use of electrical measurements as a proxy for monitoring early-age structure development and hydration progression. Correlations between electrical conductivity, heat of hydration, and storage modulus evolution provide a basis for real-time, non-destructive monitoring of material behavior during setting and hardening. Such capabilities may be leveraged for process control in additive manufacturing and quality assurance in construction applications.

The control paste and FG 30 and RG 40 graphene-modified mortar mixtures (FG 30 and RG 40 dosages of 0.02% by mass of the binder) were printed using a gantry printer equipped with a screw extruder. A circular nozzle of 20 mm diameter was used to print filaments to obtain consistent cross-section for the cylindrical geometry used for buildability evaluation. Hollow cylindrical sections were printed with an outer diameter of 120 mm and an inner diameter of 70 mm (filament width of 25 mm) at a print speed of 25 mm·s⁻¹ in-plane and 5 mm·s⁻¹ in the z-direction, and an equivalent flow rate of ~9.3 mL·s⁻¹. The layer height chosen was 15 mm, i.e., 0.75 times the nozzle diameter. Printing continued until the printed element showed instability, and the corresponding height was recorded as the experimental failure height. Prints were repeated every 30 min after mixing, starting at 30 min, until 1.5 h (after which the mixture was no longer extrudable). Extrudability is defined here as the ability to continuously extrude filaments of uniform size under a near-constant auger speed, without visible signs of cracking or other defects during printing. Companion prismatic elements were also printed to extract specimens for green compression strength tests as described below.

Viscosity recovery (paste buildability) test was carried out in a parallel plate configuration in a rheometer with multiple steps that simulate extrusion-based 3D printing process. A stepped ramp-up pre-shear phase lasting approximately 80 s was used to homogenize the suspension, after which a low shear rate of 0.1 s⁻¹ was applied for 60 s to measure the initial viscosity of the paste (before being subjected to the simulated extrusion process). A constant high shear rate of 100 s⁻¹ was then applied for 30 s to simulate the extrusion process, followed by a low shear rate of 0.1 s⁻¹ for another 60 s to measure the final viscosity of the suspension after simulated extrusion.

For the control mortar and those using 0.02% of FG 30 or RG 40 by mass of the binder, a fresh state uniaxial compression test was used along with analytical failure models to predict the buildability at different times from mixing. 20 mm wide and 80 mm long filaments were printed into a prismatic shape of 80×60×120 mm (three filaments wide and six filaments deep) at a flow rate that ensured filament overlapping to avoid discontinuities at the interfilament interfaces. A cylindrical steel tube with 50 mm inner diameter and 100 mm length was used to extract cylinders for green compression tests (GCT). GCT was carried out at three different times after mixing (0.5, 1, and 1.5 h) to extract the material properties. To ensure minimum disturbance to the specimens during their extraction, the steel tube was sharpened at one end and lubricated on the inner surface. The extracted cylinders were placed between the loading platens of a displacement-controlled testing machine (MTS Exceed Series 40 E42; rated force capacity: 5 N-5 kN) with an acrylic plate on top to ensure proper contact. Care was taken to ensure accurate contact and concentric placement. The specimens were loaded at a very slow rate of 1 mm·min⁻¹ (strain rate of 0.01 min⁻¹) until a total deformation of approximately 5 mm (about 5% strain). From the bilinear stress-strain response, material characteristics such as the plastic modulus (Eₚ), and plastic yield stress (σₚ) were extracted, to be used in models to predict the failure height. Our previous work has shown that plastic yield stress dominates the failure mode in hollow cylinders printed using the same control mortar mixture that was used in this disclosure.

Dynamic yield stress, defined as the minimum stress required to initiate the flow, is mainly governed by the particle packing or solid volume fraction. Plastic viscosity, the resistance to flow, is primarily influenced by inter-particle friction and surface contacts. The printability of a mixture—encompassing both extrudability and buildability—has been shown to be governed by its yield stress, whereas the plastic viscosity dictates the upper limits of extrusion speed. Thus, evaluating the effects of graphene addition on the dynamic yield stress and plastic viscosity of pastes serves as a good starting point for rheological assessment.

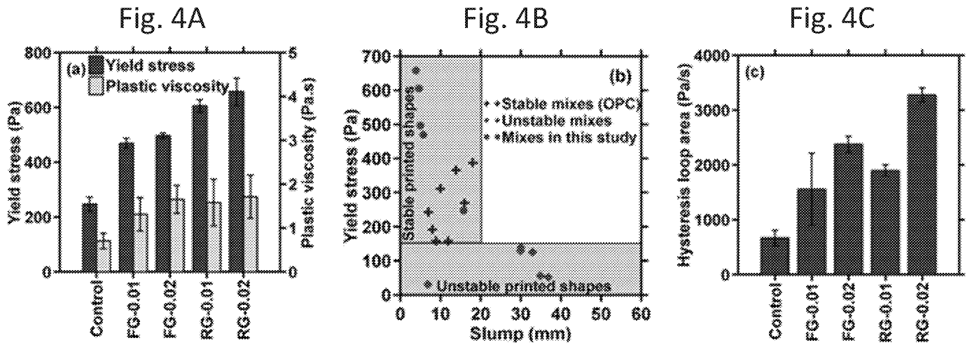

FIG. 4A shows the dynamic yield stress and plastic viscosity of all the pastes evaluated using the Bingham model. The yield stress of all the graphene-modified pastes is found to be 2-to-3 times higher than that of the control paste, with the RG 40 modified pastes exhibiting a most pronounced enhancement. This increase is attributed to improved particle packing, facilitated by the incorporation of well-dispersed graphene nanoparticles, along with a reduction in the availability of free water within the matrix. The significantly higher specific surface area of graphene particles leads to an increased extent of physical adsorption of free water, thus reducing the water availability for lubrication of particles in the paste. The presence of —COOH functional groups on the surface of RG 40 (note that FG 30 is not functionalized with any groups, and has an elementally pure fractal structure) reduces the Van der Waal's forces between the sheets and aid in better dispersion within the paste compared to FG 30 particles, consequentially retaining the high specific surface area and increasing the interparticle contacts, and providing higher yield stress of the RG 40 modified pastes. It is also theorized that the negatively charged RG 40 particles (because of —COOH functional groups) result in more electrostatic interactions in the system than the charge-less FG 30 particles, thus accelerating the mobility of ions, especially Ca²⁺. Zeta potential measurements have shown that Ca²⁺ particles released from cement are adsorbed on functionalized graphene surfaces (RG 40 in this case), thereby developing ionic clusters that enhance the formation of hydrate nuclei, which also contributes to the higher yield stress of the RG 40 modified pastes. Higher yield stress (within limits) is beneficial for the buildability of printed elements. The plastic viscosities of both FG 30 and RG 40 modified pastes are similar as plastic viscosity is more closely related to the properties of the fluid as well as the solid fraction in the suspension, which are similar for both graphene types.

In some embodiments, the increase in yield stress, plastic viscosity, and thixotropy observed in FG30 and RG40 graphene-modified cementitious mixtures is attributed to particle-scale interactions introduced by graphene. The high specific surface area of graphene (on the order of ~200 m²/g) increases water adsorption and reduces free water available for particle lubrication, thereby increasing resistance to flow. Additionally, FG30 and RG40 graphene particles promote flocculation and interparticle bridging within the cementitious matrix. In the case of RG40, the presence of carboxyl functional groups enhances electrostatic interactions with positively charged cement particles (e.g., Ca²⁺ ions), further increasing agglomeration and structural buildup. These mechanisms contribute to higher yield stress and improved shape stability, which are critical for extrusion-based 3D printing processes.

Mini slump values and dynamic yield stress have been related to the printability of cementitious pastes. FIG. 4B shows the yield stress and mini slump values of the FG30 and RG40 graphene-modified pastes. It can be seen that all FG30 and RG40 graphene modified pastes fall in the domain of printable mixtures, which is generally defined by lower mini slump and moderate-to-high yield stress values.

Thixotropy, which refers to time-dependent, reversible changes in material properties such as yield stress, is reported to aid buildability of 3D printed concrete. Here, the hysteresis loop area between the ascending and descending stages of the flow curves (shear stress vs. shear rate curves) obtained from the step-strain ramping protocol may be used as an indicator of short-term thixotropy. During strain sweep experiments, the microstructure breaks down at higher shear rates and starts to build up when the shear rate is lowered, and hence the shear stress does not trace the same path during the down-sweeps and up-sweeps. Since short-term thixotropy is primarily aided by colloidal flocculation, the hysteresis loop area can be considered to represent the difference in energy needed to break and reform flocs. The hysteresis loop areas of the control paste and FG30 and RG40 graphene modified pastes are shown in FIG. 4C. The addition of FG30 and RG40 graphene significantly enhances the short-term thixotropy of the graphene modified pastes through an increase in interparticle contacts (which is the also reason for increased viscosity). Thus, small dosages of FG30 and RG40 graphene may be effectively used to enhance the thixotropy of pastes, which consequentially helps in attaining better buildability. FIGS. 4A and 4C can be used to infer that the yield stress and hysteresis loop area are reasonably related in a linear fashion. The hysteresis loop area (the larger the area, the higher the short-term thixotropy) reflects the energy involved in the formation and breaking down of flocs, and a higher energy requirement for deflocculation indicates a higher dynamic yield stress. The numbers next to FG 30 and RG 40 indicate the fractal or reactive graphene dosage as a % by mass of binder.

In some embodiments, FG 30 and RG 40 graphene-modified cementitious mixtures exhibit enhanced short-term thixotropy, characterized by increased hysteresis loop area in shear rate ramp tests. This behavior reflects a greater energy requirement for breakdown and reformation of particle flocs, indicating stronger and more rapidly rebuilding microstructures. The increased thixotropy is associated with higher interparticle contact density and ionic interactions in the pore solution. Enhanced thixotropic behavior enables improved layer-by-layer stability during printing by allowing the material to flow under shear during extrusion while rapidly rebuilding structure after deposition. This reversible structural evolution is critical for maintaining dimensional accuracy and preventing collapse in 3D printed elements.

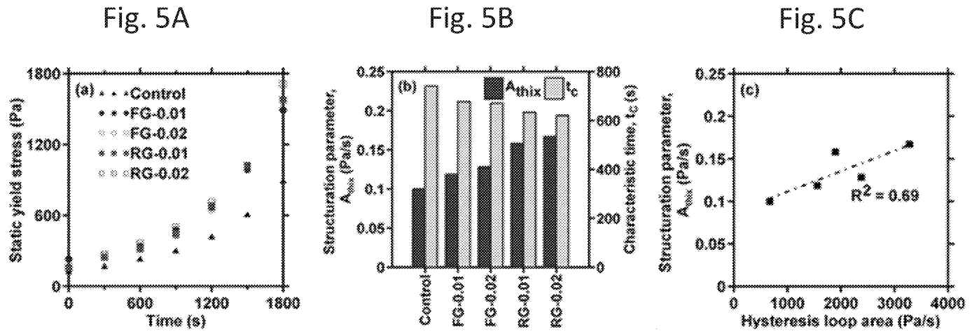

FIG. 5A shows the static yield stress evolution (until 30 min) for the control past and FG30 and RG40 graphene-modified pastes. Adding FG 30 or RG 40 increases the static yield stress of the pastes, with a slightly higher static yield stress increase observed for the RG 40 modified pastes. Monitoring the evolution of static yield stress allows tracking of the structural build-up in cement pastes, which is critical in 3D printing applications. Static yield stress arises from a combination of colloidal interactions, particle flocculation, and the bridging of particles induced by the formation of reaction products. The flocculation process lasts only for a very short time after mixing, following which the structural build-up is dominated by the rate of formation of reaction products. The higher static yield stress of both FG 30 and RG 40 modified pastes can thus be attributed to: (a) increased interparticle contacts, and (b) enhancement of cement hydration in the presence of these particles due to filler effect. In some embodiments, the inclusion of fractal graphene (FG) or reactive fractal graphene (RG) influences early-age hydration kinetics and microstructural development of cementitious materials. Experimental observations indicate that FG 30 or RG 40 graphene nanoparticles act as nucleation sites that accelerate hydration reactions, resulting in increased formation of hydration products and improved solid-phase connectivity within the matrix. This enhanced hydration leads to faster structuration and early-age stiffness development, which is particularly beneficial for additive manufacturing applications where rapid buildability is required. Additionally, storage modulus evolution and calorimetry measurements demonstrate that FG 30 or RG 40 graphene-modified systems exhibit faster structural buildup compared to control mixtures, indicating improved early-age performance and stability.

Static yield stress evolution is generally described using an exponential function (Equation 2) that incorporates a structuration parameter, Aₜₕᵢₓ.

τ₀(t)=τ_{0,0}+Aₜₕᵢₓt_{c}(e^{t}^{ᵣₑₛₜ}^{/t}^{_{c}}−1) (2)
where t_{c} is the characteristic time.

FIG. 5B shows the structuration parameter, Aₜₕᵢₓ, and characteristic time, t_{c}, obtained after fitting the exponential model (Equation 2) to the data shown in FIG. 5A for the control and FG 30 and RG 40 graphene-modified pastes. It can be seen in FIG. 5B that the structuration parameter is higher by 20-60% for the FG 30 and RG 40 graphene-modified pastes, and the characteristic time is lower by 10-15% as compared to the control paste. This indicates that the addition of FG 30 and RG 40 could contribute to enhancing the shape stability and buildability of the binders (which is confirmed in a later section using printing of hollow cylinders). FIG. 5C shows the relationship of the structuration parameter with the hysteresis loop area obtained from the strain-controlled shear rate ramp disclosure, indicating correspondence between short-term thixotropy and structuration rate. In the mixtures evaluated in this disclosure, short-term thixotropy, measured immediately after mixing within just 5 minutes, and serves as a reliable proxy for the structuration parameter, which typically requires 30 minutes to assess. This suggests the potential for a more rapid qualification of binders, streamlining the evaluation process in concrete 3D printing.

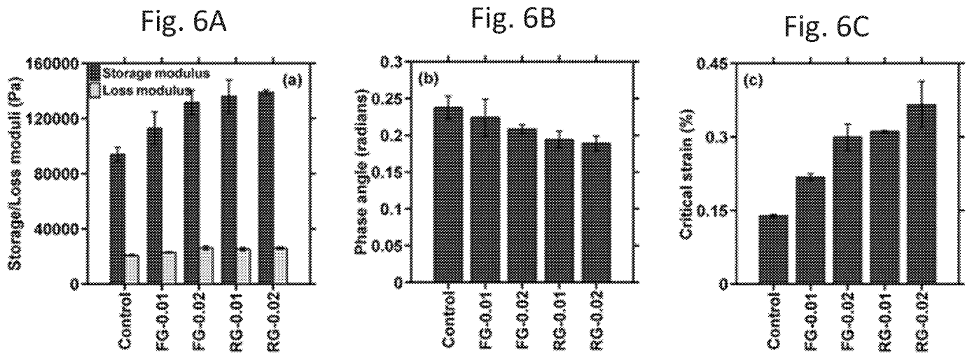

Oscillatory rheology experiments enable the characterization of the structure of binders without disturbing the microstructure. Viscoelastic properties of FG 30 and RG 40 graphene-modified pastes immediately after mixing were evaluated using strain amplitude sweep tests. FIG. 6A shows the average storage and loss moduli (i.e., elastic and viscous response) of the control and the FG 30 and RG 40 graphene-modified pastes. The storage and loss moduli in the Linear Viscoelastic Region (LVR) are higher for the FG 30 and RG 40 graphene-modified pastes, and they increase with an increase in FG 30 and RG 40 graphene dosage. The presence of rigid graphene nanoparticles also contribute to the increased stiffness of the modified paste. The higher storage modulus enables the printed layers to better retain stability and carry the superimposed layers more effectively without deformation. RG 40 modified pastes demonstrate higher storage moduli, which is in line with the particle characteristics and their early-age interactions in the cementitious systems.

The viscoelastic phase angle, given by the ratio of the loss to the storage moduli in the LVR, is shown in FIG. 6B for all the pastes. A lower value of the phase angle represents a more solid or elastic behavior, and a higher value indicates a more liquid or viscous response. The dominant interparticle interactions contribute to a slightly more pronounced elastic response for FG 30 and RG 40 modified pastes compared to the control paste, and consequently, lower phase angles. Critical strain, which signifies the end of LVR, is also used as an indicator of the deformation capacity of the suspension, as shown in FIG. 6C. The critical strains for the FG 30 and RG 40 graphene-modified pastes are about 1.5-2.5 times higher than those of the control paste, with more enhancement noted for the pastes modified with RG 40. While the higher interparticle contacts and interaction forces leading to a more rigid particulate network in the graphene-modified pastes is one reason for the higher critical strain, the presence of well-dispersed rigid nano platelets also allows for improving the strain capacity of the system and extends the LVR.

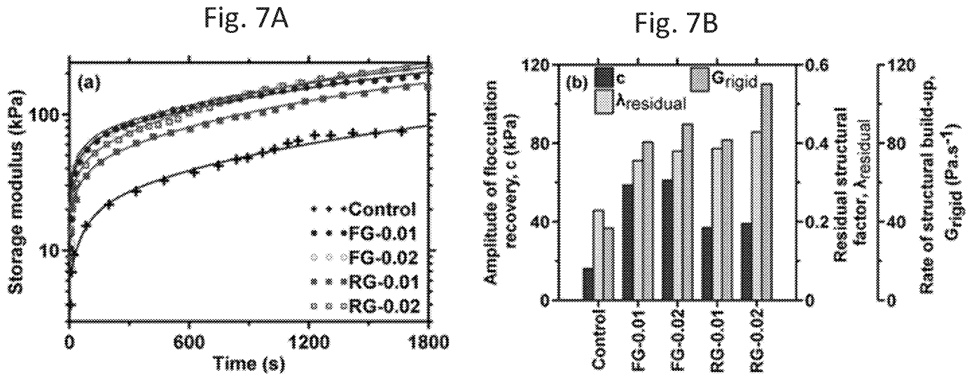

Layer-wise extrusion-based 3D printing necessitates that each extruded layer maintains its shape under the superimposed load of subsequently deposited layers. As these layers progressively develop stiffness and strength over time, understanding the temporal evolution of these properties becomes crucial for optimizing printing paths and deposition rates, as well as for determining the maximum buildable height. For stiffening soft solids, time-dependent storage modulus evolution can be used in such situations to quantify structural buildup using small amplitude oscillatory shear (SAOS) test. The storage modulus evolution shown in FIG. 7A can be described using Equation (3):

G′(t)=c(1+(λ_{residual}−1)e^{-t/θ})+G_{rigid}t (3)
where, G′ is the storage modulus (Pa), t is time(s), c is the amplitude of flocculation recovery (Pa), λ_{residual} is the residual structural factor after pre-shear (0≤λ_{residual}≤1), θ is the characteristic time(s), and G_{rigid} is the rate of structural build-up due to hydration (Pa·s⁻¹).

The first term in Equation (3) represents the flocculation recovery after pre-shear, while the second term characterizes the structural build-up of the pastes due to hydration. The addition of small amounts of FG 30 and RG 40 graphene significantly increases the storage modulus at all times, as shown in FIG. 7A, demonstrating the potential of using FG 30 and RG 40 graphene as a nano additive to manipulate the structural build-up of mixtures designed for 3D printing. The model fit results are shown in FIG. 7B. After 30 min, G′ of the FG 30 and RG 40 modified pastes are approximately 3 times higher than that of the control paste, an observation which has been noted in another recent work, where the trend remained the same even after 3 hours. This is attributed to the enhanced interparticle contacts and interactions due to uniformly dispersed stiffer FG 30 and RG 40 graphene particles as well as acceleration of cement hydration kinetics due to enhanced nucleation and growth of C—S—H via the filler effect, which is also reflected in the G_{rigid} values. The FG 30 and RG 40 graphene-modified pastes show considerably higher flocculation recovery after the imposed pre-shear in SAOS test, indicating their ability to sustain increased stresses as compared to the control mixture after extrusion. λ_{residual} values increase significantly with addition of small amounts of FG 30 and RG 40 graphene, and changes only slightly with further FG 30 and RG 40 graphene addition, a consequence of stiffer nanoparticles being capable of efficient microscale load transfer. The ability to retain microstructural integrity after pre-shear, and the filler effect on early-age reaction enable FG 30 and RG 40 graphene-modified binders to display a higher rate of recovery, and a lower characteristic time, θ. The foregoing discussion establishes the effectiveness of FG 30 and RG 40 in improving the buildability aspects in 3D printing applications.

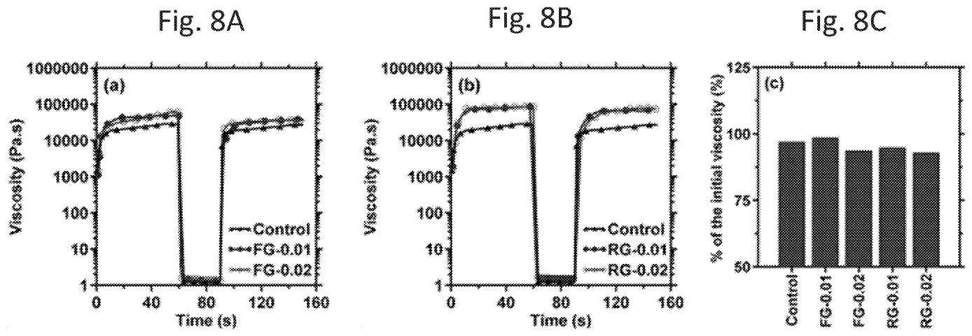

The buildability and shape stability of a 3D printed element is governed by the ability of the printed layer(s) to resist the overburden pressure due to the superimposed printed layers. Viscosity recovery tests are generally used to evaluate buildability of binders based on their ability to recover the extent of initial viscosity (at rest; simulated by a low shear rate) after being sheared at a high rate to simulate the extrusion process. FIGS. 8A and 8B show the representative viscosity recovery curves for the control paste and FG 30 and RG 40 modified pastes, and FIG. 8C quantifies the viscosity recovery of the pastes. The initial viscosities of the FG 30 and RG 40 graphene modified pastes (i.e., during the first 60 s in FIGS. 8A and 8B, which happens after the 80 s pre-shear phase that is not shown) are significantly higher than that of the control paste. The high shear rate that simulates extrusion reduces the viscosity by several orders of magnitude, enabling the flow of the material through the extruder. Here also, on close examination, the FG 30 and RG 40 graphene-modified pastes are more viscous than the control paste. Further imposition of very low shear rate reorganizes the particle-scale structure but impedes the complete recovery of viscosity. Theoretically, a material can be considered to maintain its shape if it recovers its initial viscosity after the extrusion process. All pastes studied here demonstrated a viscosity recovery rate of >95%, indicating appropriate buildability. Since the pastes under consideration showed a viscosity recovery of >95% within 60 s of being subjected to a high shear rate that simulates extrusion (FIG. 8C), it can be inferred that a top layer can be deposited without deforming the bottom layers even after a short time interval of 60 s (this is the case when hollow cylinders shown in the next section are printed). FG 30 and RG 40 graphene-modified pastes show higher initial viscosities and efficient viscosity recovery, making it likely that these mixtures will ensure enhanced buildability and shape stability as compared to the control mixtures. This is quantified using buildability experiments described below.

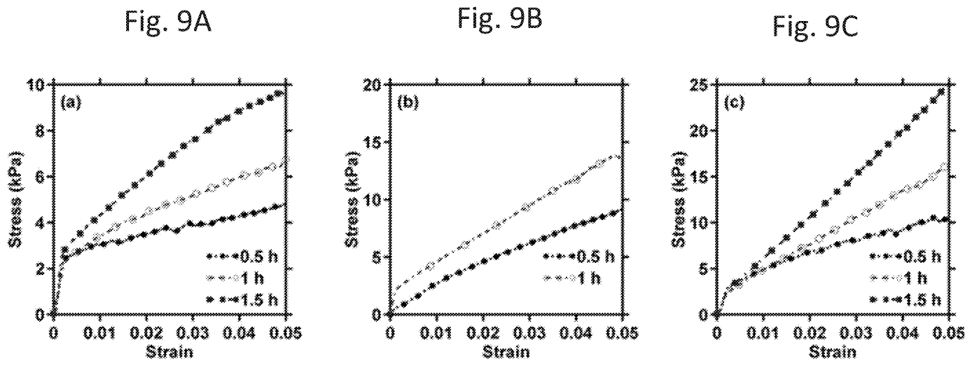

FIGS. 9A, 9B, and 9C show the representative compressive stress-strain responses of the fresh 50 mm×100 mm cylinders extracted from the prismatic prints at 30 min intervals after mixing (until 1.5 h). The slow loading rate allows the identification of a bilinear stress-strain response as described in our previous work. The stress-strain response obtained from green compression test (GCT) can be related to the incremental loading experienced by the layers during the printing process. The material extruded from the nozzle is in a plastic flow state and retains its shape once the flow ceases. This filament can elastically withstand small loads (in the strain range of ~0.0025-0.005 in FIG. 9), the end of which is termed as the elastic yield stress. When more layers are printed, the stress in one or more of the bottom layers exceeds the elastic yield stress. The slope of the linear regime, that is, the regime after the early inflection point that denotes the end of elastic regime, is termed as the plastic modulus (Eₚ). The plastic yield stress (σₚ) is the critical stress beyond which the material starts experiencing further nonlinearity. In cases where the plastic yield stress cannot be accurately identified from the stress-strain response. Only σₚ and Eₚ were considered as the buildability parameters (see Table 4) since plastic yield is the governing mode of failure for hollow cylinders. Note that the stress axes values are different for different mixtures, and that 1.5 h data could not be obtained for FG-0.02 mixture because of excessive stiffening.

Table 4 shows that the plastic yield stress and modulus are higher for the FG 30 and RG 40 graphene-modified mixtures, as expected. This demonstrates increased stiffness of the FG 30 and RG 40 graphene-modified mixtures, attributable to increased flocculation, and along with higher stiffness of the graphene particles as demonstrated by the higher structural build-up rate, contributes to better buildability. The FG 30 modified mortar mixture was not printable after 1.5 hours from mixing, and hence the GCT test could not be performed at that age. This is attributable to the formation of clumps in the FG 30 modified mixture during early hydration, aided by the highly attractive Van der Waals forces between the FG 30 graphene platelets. Since this work focused on quantifying the buildability effects of FG 30 and RG 40, efforts were not made to adjust the admixture dosage for the FG 30 and RG 40 graphene modified mixtures, which would have made the FG-0.02 mixture also printable after 1.5 h. The presence of functional groups in RG 40 has been reported to enhance the electrostatic repulsion between the sheets, thereby making the dispersion more effective, and thus, the RG 40 modified mixture was extrudable even after 1.5 hours from mixing.

TABLE 4
Plastic yield stress and plastic moduli
of the mortars extracted from GCT.

| | | Plastic yield | Plastic modulus, |
|---|---|---|---|
| Mixture ID | Time (h) | stress, σₚ (kPa) | Eₚ (kPa) |
| Control | 0.5 | 3.1 | 96 |
| | 1.0 | 4.3 | 114 |
| | 1.5 | 6.5 | 175 |
| FG-0.02 | 0.5 | 6.7 | 253 |
| | 1.0 | 11.5 | 274 |
| | 1.5 | — | — |
| RG-0.02 | 0.5 | 6.0 | 224 |
| | 1.0 | 7.2 | 299 |
| | 1.5 | 14.5 | 445 |

Higher plastic yield stress and plastic moduli of the FG 30 and RG 40 graphene-modified mixtures allow for higher buildable heights than the control mixture at any time after mixing. Table 5 shows the images of the hollow cylinders at or just before their eventual failure. The predicted and experimental failure heights of the hollow cylinders printed using the control and FG 30 and RG 40 modified mixtures are also shown in the table. The predicted failure height was determined by using the parameters obtained from the GCT as shown in Equation 4:

$${h}_{p} = \frac{{σ}_{p}}{ρ g} + {h}_{1} \qquad ( 4 )$$

where σₚ is the plastic yield stress, and hₗ is the filament layer height.

The layer height is added to indicate that the stress is being calculated at the top of the bottommost layer. Experimental failure was recorded when no more layers could be printed because of significant geometric deformation and/or collapse of the printed structure. The analytically calculated failure heights derived from plastic yield stress matches the experimental buildability heights, as can be noted from Table 5.

At an early age (i.e., 30 min after mixing), hollow cylinder prints were found to subside vertically, in line with the plastic collapse mode. At later ages, some of the prints subsided substantially, adhering to a plastic collapse mode, but did not topple over. Since the structure did lose its geometric integrity in these cases, they were considered to have failed. The FG 30 and RG 40 graphene-modified mixtures generally had buildable heights almost twice that of the control mixture, demonstrating the potential of FG 30 and RG 40 graphene to enhance the mixture buildability and help develop sustainable mixtures amenable to 3D printing. This is in line with observations from the rheological tests reported earlier. For instance, note that the rates of structural build-up (until 30 min) obtained from storage modulus evolution test (shown in FIG. 7B) for the FG-0.02 and RG-0.02 pastes were also considerably higher than that of the control paste, affirming their enhanced buildability heights. Thus, it is theorized that storage modulus evolution can be used as an apriori indicator of buildability.

Table 5 shows hollow cylinder prints for the control and FG 30 and RG 40 graphene-modified mixtures at 0.5, 1.0, and 1.5 h after mixing (Note: pictures shown are at or just before failure and hence are skewed due to plastic collapse of bottom filament). The theoretical failure height obtained using the GCT and experimental failure height recorded are also reported.

Rheological characterization is fundamental to concrete 3D printing, as each stage of the process imposes distinct and often competing demands on the material. The rheological properties essential for successful material delivery to the print head, extrusion through a nozzle, and shape stability during and after layering differ significantly and, in some cases, conflict with one another. For instance, during the material delivery phase—particularly when the mixture is pumped—both viscosity and yield stress must be sufficiently low to ensure smooth flow while preventing segregation or blockages enroute to the print head. During extrusion through the nozzle, a higher yield stress is desirable to not only maintain the shape of the extrudate but also to avoid collapse upon release from the nozzle. This phase is where the material begins to take shape, and hence structural stability (e.g., stiffness) is essential to prevent immediate collapse or excessive deformation of the printed layers. Ensuring optimal rheological properties during the extrusion phase helps prevent issues such as excessive layer spreading or drooping, which can affect both the dimensional accuracy of the structure and its ability to support subsequent layers. Following extrusion, in the post-extrusion stage, the mixture needs to rapidly gain stiffness—often achieved through tuning of the thixotropic behavior—allowing it to bear the superimposed load from successive layers without deformation. This stage is pivotal as it determines whether the structure can maintain its shape throughout the entire printing process, which is critical in enabling sufficient buildability. Ultimately, the hardened properties of the printed structure, including strength and durability, are influenced by these rheological characteristics. Poor rheological performance such as improper flow or inadequate shape retention can lead to voids and weak interfaces, thereby compromising the performance of the printed element.

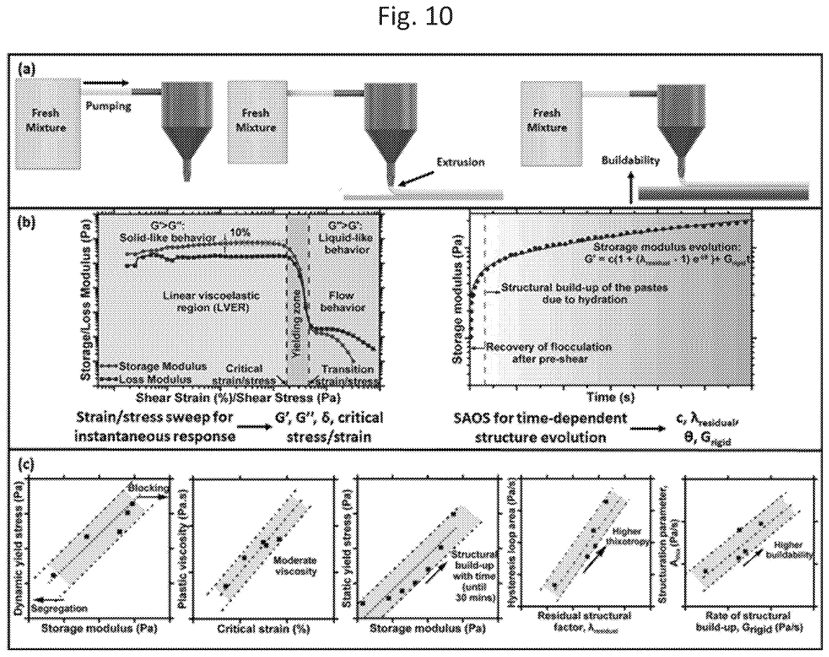

A host of rheological tests are used to qualify mixtures for 3D printing, with each test catering to a specific performance aspect. While there is value in using these tests selectively for mixture characterization and qualification, their implementation requires significant resources and time. Moreover, significant variations in rheological parameters across different printable mixtures, primarily resulting from inconsistencies in test procedures, may further complicate the standardization and comparative analysis of results. Furthermore, the results are often constrained to the specific mixtures under evaluation, limiting their broader applicability. Interpreting material behavior across multiple tests can sometimes yield conflicting conclusions, further complicating decision-making and the development of standardized assessment protocols. Hence an attempt is made here, based on the results from this work to determine if there exists one test that can provide reasonable indicators of the binders' response in all of the stages of 3D printing. It is posited that oscillatory rheology is as a promising candidate for a unified rheological test for 3D-printable binders, owing to its capability to capture both the instantaneous response of the material and its time-dependent evolution. This approach enables a more comprehensive assessment of rheological behavior across different stages of the printing process. FIG. 10 illustrates the key stages in 3D printing and highlights the rheological properties that exhibit strong correlations with oscillatory rheology-based parameters, as inferred from the current dataset.

FIG. 10 illustrates at (a) the three main stages of importance in 3DCP: pumping, extrusion, and buildability; at (b) representative data on stress/strain sweep oscillatory rheology and storage modulus evolution from small angle oscillatory shear test, along with the parameters that can be extracted; and at (c) schematic representations of relationship between oscillatory rheology parameters and other parameters of relevance in 3DCP. The symbols correspond to data from this disclosure.

Dynamic yield stress and plastic viscosity of a system are reported to be the simplest indicators of pumpability. Although low dynamic yield stress and plastic viscosity are preferred for pumpability as they reduce the risk of blockage, the potential for segregation also needs to be addressed. Therefore, moderate dynamic yield stress and plastic viscosity are preferred, depending on the pump specifications and pumping pipe. However, from a mixture design perspective, dynamic yield stress and plastic viscosity can be reliably correlated with the storage modulus and critical strain derived from stress or strain sweep oscillatory tests. These relationships provide valuable insights into the rheological behavior of 3D-printable binders, offering a more efficient means of predicting and tailoring material performance for extrusion and buildability. In general, the increase in dynamic yield stress scales linearly with the increase in storage modulus. This is expected since an increase in storage modulus value indicates more elastic behavior resulting from a more structured network with more interparticle contacts and stronger attractive forces, which is also the reason for higher yield stress. Critical strain, which indicates the end of LVR, can be related to plastic viscosity. The critical strain (or critical stress based on strain or stress sweep test performed) indicates the deformation of the weakest connections, widely attributed to the early hydration products such as C—S—H and metastable ettringite, between binder particles at early phases. A higher critical strain signifies increased or stronger interparticle connections that are likely the bridges between the binder particles. On the other hand, the plastic viscosity of cementitious paste is shown to be influenced by interparticle contacts and interparticle forces, both of which are reflected in critical strain. Therefore, the critical strain obtained from strain sweep tests can be used as a reasonable indicator of plastic viscosity, which is also supported by the results obtained in the present disclosure. Though, in principle, a simple shear rate ramp disclosure as shown earlier in this paper is a convenient test to determine yield stress and plastic viscosity, oscillatory rheology can provide indicators of these properties as well as many others, making it more valuable in the context of 3DCP.

When the fresh mixture reaches the print head, it is in a resting state, making structural build-up at rest a critical factor. The structural build-up at rest is commonly evaluated through the evolution of static yield stress. As shown in FIG. 10, the static yield stress evolution is well related with the storage modulus evolution. In contrast to static yield stress evolution tests, SAOS test allows continuous monitoring of evolution of storage modulus and extraction of additional parameters of importance in structural build-up. As an example, short-term thixotropy, represented by the hysteresis loop area, scales linearly with the residual structural factor, λ_{residual}. Thixotropy allows to the binder to regain its original properties through re-flocculation after it has been subjected to shearing during extrusion, thus determining its ability to retain its shape after layer deposition. Since the hysteresis loop area reflects the energy involved in floc formation and separation, λ_{residual}, the residual structural factor after pre-shear—which represents the magnitude of early-age flocculation in the paste as obtained from SAOS test—can be used an indicator of short-term thixotropy. Short-term thixotropy is important immediately after the material is extruded from the nozzle and printed as a filament.

In order to support the self-weight of a layer and those of the subsequently deposited layers (i.e., enabling buildability), the structural build-up rate, often represented by the structuration rate parameter, Aₜₕᵢₓ, is important. The structuration parameter, Aₜₕᵢₓ, typically obtained from a static yield stress evolution test and the rate of structural build-up, G_{rigid}, from SAOS test are linearly related as shown in FIG. 10 at (c). This is expected since both the tests track the structural build-up due to the formation of early-age hydration products. SAOS provides a more robust means of continuous monitoring of storage modulus without disturbing the microstructure due to the strains imposed being smaller than those in a static yield stress evolution test.

Therefore there is a strong rationale for adopting oscillatory rheology as a unified test method for characterizing 3D-printable binders. This rationale is grounded in both experimental findings and fundamental relationships among various rheological parameters. The standardization of a test protocol capable of quantifying the time- and shear history-dependent rheological response while simultaneously tracking microstructural evolution would be highly advantageous for the concrete 3D printing industry, paving the way for more reliable and reproducible material assessments.

Based on the example samples, the dynamic yield stress of FG 30 and RG 40 modified pastes were 2-3 times higher than those of the control paste, with the RG 40 modified mixtures showing enhancement due to the electrostatic interactions and filler effect promoted by the functional groups. Short-term thixotropy, quantified using the hysteresis loop area of the flow curves, was found to be significantly enhanced by the addition of graphene, alluding to their potential to enhance buildability. Short-term thixotropy was also found to be linearly related to the dynamic yield stress. Static yield stress evolution, monitored for 30 min, also showed the influence of FG 30 and RG 40, with the yield stress values of the FG 30 and RG 40 modified pastes being more than two times as that of the control pastes after 30 minutes. Structuration parameter (Aₜₕᵢₓ) derived from an exponential fit of temporal variation of static yield stress was higher by 20-50% for the graphene-modified pastes, while the characteristic time was lower by 10-25% as compared to the control paste. These parameters provided further indications of enhanced buildability of FG 30 and RG 40 modified pastes. Accelerated structural build-up is essential for 3D printing, as it allows the extruded layers to rapidly gain strength, preventing deformation as additional layers are added. This was further confirmed using buildability tests where hollow cylindrical sections were printed using FG 30 and RG 40 modified mortars. The hollow cylinders failed in plastic collapse, with the failure heights of FG 30 and RG 40 modified mortars measuring 2-3 times greater than those of the control mortars. This significant improvement underscores the enhanced buildability imparted by these modifications. The analytical predictions of buildability using parameters derived from green compression test also matched the experimental values.

Unlike conventional concrete, the rheological parameters for 3D printed concrete are designed to ensure desired extrudability and buildability, which sometimes are at odds with each other. Based on the rheological tests on 3D printable binders, an attempt was made to determine if any one test could be versatile enough to provide reasonable indicators of the rheological response across temporal scales to capture aspects related to material delivery, extrusion, and buildability. Oscillatory rheology (stress or strain sweep and SAOS) satisfied several of the requirements, and along with parameters derived from a model that describes storage modulus evolution with time, enabled the determination of properties required during different stages of 3D printing. Standardizing a test procedure that has the potential to quantify the temporal and shear history-dependent properties of fresh mixtures used in 3D printing is expected to be valuable for the concrete 3D printing industry.

In aspects, the FG 30 and RG 40 graphene-enhanced cementitious compositions described herein may be evaluated using a cradle-to-gate life cycle analysis (LCA) framework that includes raw material production, transportation, and mixture preparation. The functional unit for such analysis may comprise one cubic meter of mortar or concrete, and system boundaries may include production of ordinary Portland cement, graphene materials, aggregate processing, mixing, and transportation. Environmental impacts may be quantified using life cycle impact assessment methodologies including global warming potential (GWP) and energy demand.

In aspects, life cycle inventory data associated with material production and transportation may be used to calculate total energy consumption and carbon emissions based on energy density and carbon intensity factors. The FG 30 and RG 40 graphene materials described herein, due to their ultra-low dosage, may contribute negligible transportation-related emissions, while still providing significant performance enhancements to the cementitious compositions.

In aspects, the evolution of static yield stress in the disclosed FG 30 and RG 40 graphene-enhanced cementitious mixtures may be modeled using an exponential structuration function that includes a structuration parameter and a characteristic time constant. The structuration parameter may increase with the addition of FG 30 and RG 40 graphene materials, indicating accelerated structural build-up, while the characteristic time may decrease, reflecting faster development of load-bearing capacity in the mixture.

In aspects, thixotropic behavior of the FG 30 and RG 40 cementitious mixtures may be quantified using a hysteresis loop area derived from shear rate ramp testing, wherein the loop area represents the energy required to break and reform particle flocculation networks. The incorporation of FG 30 and RG 40 may increase the hysteresis loop area, thereby enhancing thixotropy and improving buildability and shape retention during additive manufacturing processes.

In aspects, viscoelastic properties of the mixtures may be characterized using oscillatory rheology parameters including storage modulus, loss modulus, phase angle, and critical strain. The addition of FG 30 and RG 40 graphene materials may increase storage modulus and reduce phase angle, indicating a more elastic response, thereby improving the ability of deposited layers to support subsequent layers in a layer-by-layer printing process.

In aspects, structural build-up over time may be quantified using storage modulus evolution, wherein contributions from flocculation recovery and hydration-driven stiffening are modeled. FG 30 and RG 40 graphene-enhanced mixtures may exhibit increased storage modulus and accelerated development over time, enabling improved control of printing parameters including deposition rate and maximum buildable height.

In aspects, incorporation of FG 30 and RG 40 into cementitious materials may result in microstructural densification characterized by reductions in total porosity and average pore size. Such densification may include porosity reductions on the order of approximately 20% to 40% and reductions in average pore size of up to approximately 50%, relative to control compositions. These effects may be attributed to enhanced nucleation and growth of hydration products facilitated by graphene particles.

In aspects, FG 30 and RG 40 graphene-enhanced cementitious compositions may exhibit reduced critical pore diameter and refined pore size distribution, resulting in improved transport properties including reduced permeability and diffusivity. Electrical impedance spectroscopy may be used to determine pore network tortuosity and effective conductivity, which may be further used to estimate gas diffusion coefficients and durability-related transport characteristics.

In aspects, FG 30 and RG 40 graphene particles may enhance the interfacial transition zone (ITZ) within cementitious composites by promoting localized hydration product formation at particle surfaces, thereby improving bonding and load transfer between phases and enhancing overall mechanical performance.

In aspects, hydration kinetics of the disclosed FG 30 and RG 40 cementitious compositions may be modeled using a phase boundary nucleation and growth (pBNG) framework, wherein calcium silicate hydrate (C—S—H) formation is governed by site-saturation nucleation followed by anisotropic growth on solid surfaces. The model may assume that nuclei are formed during an initial nucleation period and that subsequent growth occurs without additional nucleation events.

In aspects, FG 30 and RG 40 graphene particles provide additional effective surface area for heterogeneous nucleation of hydration products, thereby increasing hydration rates and structural development. The effective surface area fraction may depend on dispersion quality, agglomeration state, and chemical interactions within the cementitious matrix.

In aspects, the pBNG model may incorporate parameters including nucleation density, growth rates, boundary surface area, and water-to-binder ratio to simulate hydration behavior and predict microstructural evolution of FG 30 and RG 40 graphene-enhanced cementitious compositions. Such modeling may be used to optimize graphene dosage and mixture design for desired mechanical and rheological performance.

In aspects, the FG 30 and RG 40 graphene-enhanced cementitious compositions may be evaluated using a cradle-to-gate life cycle analysis (LCA) framework that includes raw material production, transportation, and mixture preparation. The functional unit for such analysis may be one cubic meter of mortar, and system boundaries may encompass the production of cement, FG 30 and RG 40 graphene materials, aggregate processing, and mixing operations. Environmental impacts may be quantified using life cycle impact assessment (LCIA) methodologies, including but not limited to global warming potential (GWP) and energy demand, based on standardized tools such as TRACI. The analysis may incorporate life cycle inventory (LCI) datasets corresponding to material production and transport, and may further calculate total energy consumption and carbon emissions based on energy density and carbon intensity factors.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A 3D-printable cementitious mixture comprising:
hydraulic cement;
water;
a superplasticizer; and
fractal graphene (FG) or reactive fractal graphene (RG) in an amount of 0.01% to 0.02% by mass of binder.

2. The 3D-printable cementitious mixture of claim 1, wherein the mixture exhibits a mini slump value between about 3 mm and about 6 mm.

3. The 3D-printable cementitious mixture of claim 1, wherein the static yield stress evolution follows an exponential function indicative of enhanced structuration and early-age strength development.

4. The 3D-printable cementitious mixture of claim 1, wherein the fractal graphene (FG) is produced through chamber explosion synthesis.

5. The 3D-printable cementitious mixture of claim 1, wherein the reactive fractal graphene (RG) comprises fractal graphene (FG) functionalized with carboxyl (—COOH) groups.

6. The 3D-printable cementitious mixture of claim 1, wherein the 3D-printable cementitious mixture has a viscosity recovery of at least 95% after extrusion.

7. The 3D-printable cementitious mixture of claim 1, wherein the superplasticizer is a polycarboxylate ether (PCE)-based superplasticizer.

8. The 3D-printable cementitious mixture of claim 1, wherein the mixture exhibits a dynamic yield stress at least about two times greater than a corresponding mixture without graphene.

9. The 3D-printable cementitious mixture of claim 1, wherein the mixture has increased thixotropy relative to a control composition without graphene.

10. A method of producing a graphene-enhanced cementitious composition, comprising:
dispersing fractal graphene (FG) or reactive fractal graphene (RG) in water using ultrasonication;
mixing the dispersed graphene with a hydraulic cement; and
adding additional water to achieve a desired water-to-cement ratio.

11. The method of claim 10, wherein the ultrasonication process is performed at a frequency of 40 kHz.

12. The method of claim 11, wherein the ultrasonication process is performed for at least 30 minutes.

13. The method of claim 10, wherein a superplasticizer is added during the dispersion process to improve the stability of the graphene suspension.

14. The method of claim 10, wherein the fractal graphene (FG) or reactive fractal graphene (RG) is homogenized in water prior to ultrasonication.

15. The method of claim 10, wherein the dispersing step further comprises adding a superplasticizer at a mass ratio of about 1:1 relative to the fractal graphene (FG) or reactive fractal graphene (RG).

16. A method for additive manufacturing of a cementitious structure, comprising:
preparing a 3D-printable cementitious mixture including fractal graphene (FG) or reactive fractal graphene (RG);
extruding the mixture layer-by-layer using a 3D printing system; and
allowing the printed structure to gain strength through controlled hydration and structuration.

17. The method of claim 16, wherein the extruding is performed using a robotic or gantry-based 3D printer.

18. The method of claim 16, wherein the cementitious mixture exhibits a buildable height at least up to about two times greater than a comparable mixture without graphene.

19. The method of claim 16, wherein the printed structure exhibits enhanced early-age strength due to accelerated hydration.

20. The method of claim 16, wherein the cementitious mixture exhibits a viscosity recovery of at least 95% after extrusion, enabling the printed structure to retain shape stability during layer-by-layer deposition.
